(19) United States
(12) Patent Application Publication
(10) Pub. No.: US 2019/0377548 A1
(43) Pub. Date: Dec. 12, 2019

(54) ARITHMETIC PROCESSING APPARATUS, CONTROL METHOD, AND RECORDING MEDIUM

(71) Applicant: FUJITSU LIMITED, Kawasaki-shi (JP)

(72) Inventor: Manabu Matsuyama, Kawasaki (JP)

(73) Assignee: FUJITSU LIMITED, Kawasaki-shi (JP)

(21) Appl. No.: 16/401,128

(22) Filed: May 2, 2019

(30) Foreign Application Priority Data
Jun. 6, 2018 (JP) 2018-108780

(51) Int. Cl. G06F 7/485; G06F 7/487

(52) U.S. Cl. CPC G06F 7/485; G06F 7/4876

(57) ABSTRACT

An arithmetic processing apparatus includes a memory; and a processor coupled to the memory and configured to: acquire input data and output data in each of a plurality of operations using predetermined data for an information processing including the plurality of operations of a floating-point format to, extract a specific operation represented by a complicated function including at least a transcendental function among the plurality of operations, obtain an alternative function having a smaller computation amount than the complicated function in the extracted specific operation based on the input data, and substitute the specific operation in the information processing with the alternative function.

### CROSS-REFERENCE TO RELATED APPLICATION

This application is based upon and claims the benefit of the prior Japanese Patent Application No. 2018-108780, filed on Jun. 6, 2018, the entire contents of which are incorporated herein by reference.

### FIELD

The embodiments discussed herein are related to an arithmetic processing apparatus, a control method, and a recording medium.

### BACKGROUND

In recent years, there has been an increasing interest in problem solving by artificial intelligence, especially by a novel method of a deep learning, and techniques have been required to efficiently implement the deep learning. In the deep learning, the requirement for individual computational accuracy is not as rigorous as other computing. For example, in the signal processing of the related art and the like, a programmer develops a computer program so as not to generate an overflow as much as possible. Meanwhile, the deep learning permits for a large value to be saturated to some extent. This is because, in the deep learning, an adjustment of coefficients when a convolution operation is performed on a plurality of input data is the main processing and extreme data among the input data are not often regarded as important.

Considering such characteristics of the deep learning, for example, there has been proposed a technique using a fixed-point format instead of a floating-point format normally used for numerical expression as one of the techniques for efficiently implementing the deep learning.

Here, a procedure in the related art for transforming information processing using a floating-point format for numerical expression into information processing dealing with numerical values of a 16-bit or 8-bit fixed-point point format will be described below. First, an arithmetic processing apparatus processes sample data with information processing when a floating-point format is used for numerical expression. Next, the arithmetic processing apparatus determines whether or not each operation included in the information processing can be transformed into a fixed-point format. Specifically, the following processing is repeated.

First, the arithmetic processing apparatus determines whether or not the operation is a transcendental function. When the operation is a transcendental function, the arithmetic processing apparatus proceeds to the next operation. Here, the transcendental function refers to a function which may greatly differ in the number of digits of the answer to the input data. More specifically, the transcendental function is a function that is difficult to be expressed using algebraic operations such as addition, multiplication, and power roots a finite number of times, in other words, an analytic function that does not satisfy the polynomial equation. For example, an exponential function, a logarithmic function, a trigonometric function and the like are transcendental functions. When the operation is not a transcendental function, the arithmetic processing apparatus checks the frequency distribution of the maximum value and the minimum value of the input/output data of the operation. When the frequency distribution of the maximum value and the minimum value of the input/output data of the operation falls within a certain range, the arithmetic processing apparatus determines that the operation can be transformed into a fixed-point. Then, the arithmetic processing apparatus records a decimal point position in a fixed-point format suitable for each variable of the operation. Meanwhile, when the frequency distribution of the maximum value and the minimum value does not fall within the certain range, the arithmetic processing apparatus proceeds to the next operation.

When the determination as to whether or not each operation can be transformed into the fixed-point format is completed, the arithmetic processing apparatus scans the information processing in an order from the top, specifies each operation determined to be transformable into the fixed-point format, and transforms the specified operation into a fixed-point format. Next, the arithmetic processing apparatus specifies an operation in which the input data is of a floating-point format, among operations determined to be transformable into the fixed-point format. Then, the arithmetic processing apparatus inserts a process of transforming the input data into a fixed-point format by using the decimal point position when the specified operation is transformed into the fixed-point format.

After completing the transformation of transformable operation into the fixed-point format, the arithmetic processing apparatus adjusts the input/output of an operation which cannot be transformed into a fixed-point format, according to the following method. The arithmetic processing apparatus scans the information processing in order from the top and specifies an operation whose input data is of a fixed-point format, among operations which cannot be transformed into the fixed-point format. Then, the arithmetic processing apparatus inserts a process of transforming the input data of each specified operation from the fixed-point format to the floating-point format. Next, the arithmetic processing apparatus scans the information processing in an order from the top and specifies an operation in which the output data is input data of an operation of other fixed-point format, among the operations which cannot be transformed into the fixed-point format. Then, the arithmetic processing apparatus inserts a process of transforming the output data of each specified operation to the fixed-point format by using the decimal point position at the time of transforming an operation next to the specified operation into the fixed-point format.

After completing the adjustment of the input/output of the operation that cannot be transformed into the fixed-point format, when the final output is of a floating-point format, the arithmetic processing apparatus adjusts the final output by inserting a process of transforming the final output into the fixed-point format. Thus, the arithmetic processing apparatus can transform information processing using the floating-point format for numerical expression into information processing using numerical expression of the fixed-point format.

Considering the design of an arithmetic circuit, it is difficult to design an arithmetic circuit of a transcendental function which handles numerical data of a fixed-point format which is a predetermined decimal point position. Therefore, when an operation using the transcendental function is included in the information processing, even when the frequency distribution of given sample data falls within a range that allows transformation into the fixed-point format, it is difficult to transform the operation to the fixed-point format. Therefore, in the process of transformation into the fixed-point format in the related art, the arithmetic processing apparatus leaves the operation in the floating-point format, as described above, when the operation is represented by the transcendental function, and inserts a process of transforming the data format between the operation and operations of a fixed-point format before and after the operation.

In addition, as one of techniques for transforming an operation of a floating-point format into an operation of a fixed-point format, another related art has been known which outputs a change in value of a target variable as a history and transforming an operation into a fixed-point format based on the range of values of the detected target variable.

Related techniques are disclosed in, for example, Japanese Laid-open Patent Publication No. 2008-033729.

### SUMMARY

According to an aspect of the embodiments, an arithmetic processing apparatus includes a memory; and a processor coupled to the memory and configured to: acquire input data and output data in each of a plurality of operations using predetermined data for an information processing including the plurality of operations of a floating-point format to, extract a specific operation represented by a complicated function including at least a transcendental function among the plurality of operations, obtain an alternative function having a smaller computation amount than the complicated function in the extracted specific operation based on the input data, and substitute the specific operation in the information processing with the alternative function.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating a hardware configuration of an arithmetic processing apparatus;

FIG. 2 is a block diagram of the arithmetic processing apparatus;

FIG. 3 is a view for explaining determination processing of Q notation;

FIG. 4 is a view illustrating a transcendental function and a linear approximation expression;

FIG. 5 is a view for explaining an error between the transcendental function and the linear approximation expression;

FIG. 6 is a flowchart of a deep learning processing by an arithmetic processing apparatus according to a first embodiment;

FIG. 7 is a flowchart of transformation processing of a floating-point version program into a fixed-point version program;

FIG. 8 is a flowchart of extraction of transformable operation and replacement of a complicated function; and

FIG. 9 is a view for explaining a flow of entire deep learning by the arithmetic processing apparatus according to the first embodiment.

### DESCRIPTION OF EMBODIMENTS

The operation of a transcendental function tends to increase the hardware cost, operation execution time, and power consumption, as compared with normal operations. Therefore, when a transcendental function is left as in the transformation into the fixed-point format in the related art, there is a possibility that some of advantages such as reduction in size, power saving, and speeding-up of a circuit due to the transformation into the fixed-point format are canceled out. In addition, since a process of format transformation between a floating-point format and a fixed-point format is inserted before and after the operation including the transcendental function, extra cost and time may be required.

In addition, even in the related art that transforms into the fixed-point format according to the range of values of the detected target variable based on a history, since handling of a transcendental function is not taken into consideration, it is difficult to implement a reduction in size, power saving, and speeding-up of a circuit.

Although a transcendental function has been described here, the same problem arises in functions where a design of an arithmetic circuit is difficult. One of such function where a design of an arithmetic circuit is difficult other than the transcendental function is, for example, a square root.

Hereinafter, embodiments of an arithmetic processing apparatus, a control program of the arithmetic processing apparatus, and a control method of the arithmetic processing apparatus according to the present disclosure will be described in detail with reference to the accompanying drawings. In addition, the arithmetic processing apparatus, the control program of the arithmetic processing apparatus, and the control method of the arithmetic processing apparatus according to the present disclosure are not limited by the following embodiments.

### First Embodiment

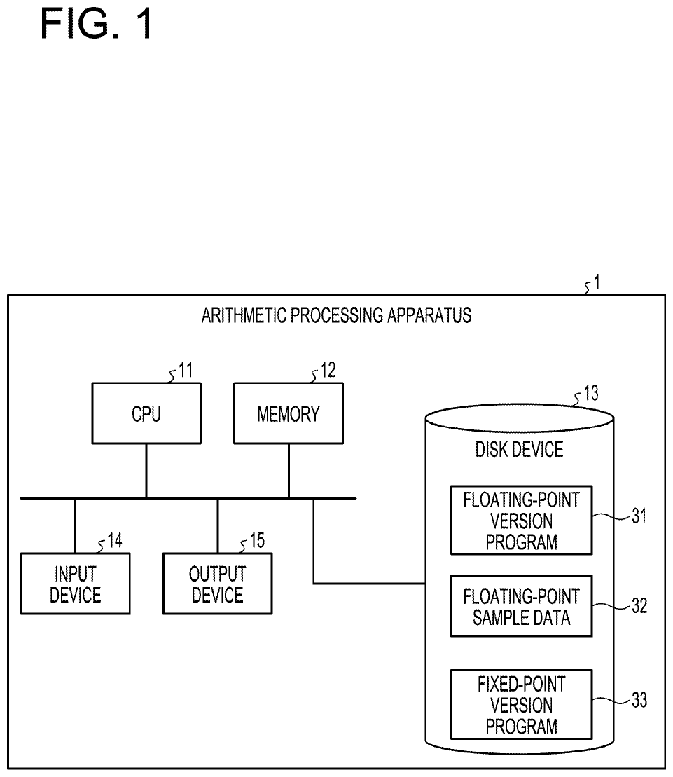

FIG. 1 is a view illustrating a hardware configuration of an arithmetic processing apparatus. The arithmetic processing apparatus 1 may be a computer such as a server device. As illustrated in FIG. 1, the arithmetic processing apparatus 1 includes a CPU 11, a memory 12, a disk device 13, an input device 14, and an output device 15. The CPU 11 is connected to the memory 12, the disk device 13, the input device 14, and the output device 15 via a bus.

The disk device 13 includes a storage medium such as a hard disk. In the present embodiment, the disk device 13 pre-stores a floating-point version program 31 and floating-point sample data 32 which are input by a user using the input device 14. The floating-point version program 31 is, for example, a deep learning program in which a floating-point format is used for numerical expression. That is, the floating-point version program 31 is a program which is given input data of a floating-point format and performs calculation using numerical values of a floating-point format. The floating-point version program 31 includes operations of a plurality of floating-point formats. For example, the floating-point version program 31 includes operations to be executed in layers such as a convolution layer, a pooling layer, a fully connected layer, and a Softmax layer in the deep learning. The floating-point sample data 32 is input data for a sample of the floating-point version program 31. In other words, the floating-point sample data 32 is predetermined data and may be any data as long as the floating-point version program 31 operates normally with the data. The floating-point sample data 32 has a value of a floating-point format. The floating-point version program 31 is an example of “information processing.”

After the floating-point version program 31 is transformed into a fixed-point format which will be described later, the disk device 13 stores a fixed-point version program 33 as a result of the transformation. The fixed-point version program 33 is a deep learning program in which a fixed-point format is used for numerical expression. That is, the fixed-point version program 33 is a program that is given input data of a fixed-point format and performs calculation using numerical values of a fixed-point format.

Further, the disk device 13 has various programs including a program for implementing the function of transforming an operation of a floating-point format which will be described later into an operation of a fixed-point format.

The memory 12 is a main memory such as a DRAM (Dynamic Random Access Memory) or the like. The input device 14 is, for example, a keyboard, a mouse or the like. A user of the arithmetic processing apparatus 1 uses the input device 14 to input data and instructions to the arithmetic processing apparatus 1. The output device 15 is, for example, a monitor or the like. The user of the arithmetic processing apparatus 1 uses the output device 15 to check a result of the calculation by the arithmetic processing apparatus 1, etc.

The CPU 11 reads out various programs stored in the disk device 13, deploys the programs on the memory 12, and executes the programs. Thus, for example, the CPU 11 implements the function of transforming an operation of a floating-point format (which will be described later) into an operation of a fixed-point format and the function of the deep learning.

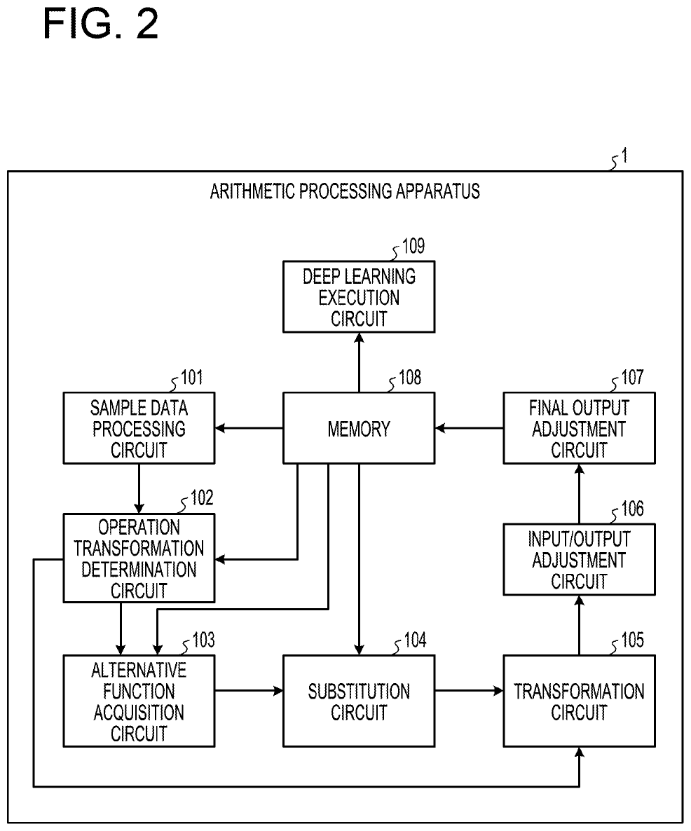

Next, the function of transforming the operation of the floating-point format into the operation of the fixed-point format by the arithmetic processing apparatus 1 according to the present embodiment will be described with reference to FIG. 2. FIG. 2 is a block diagram of the arithmetic processing apparatus.

As illustrated in FIG. 2, the arithmetic processing apparatus 1 includes a sample data processing circuit 101, an operation transformation determination circuit 102, an alternative function acquisition circuit 103, a substitution circuit 104, a transformation circuit 105, an input/output adjustment circuit 106, and a final output adjustment circuit 107. The arithmetic processing apparatus 1 further includes a memory 108 and a deep learning execution circuit 109. The sample data processing circuit 101, the operation transformation determination circuit 102, the alternative function acquisition circuit 103, the substitution circuit 104, the transformation circuit 105, the input/output adjustment circuit 106, the final output adjustment circuit 107, and the deep learning execution circuit 109 are implemented by the CPU 11 executing the various programs stored in the disk device 13.

The memory 108 is implemented by the disk device 13 illustrated in FIG. 1. The memory 108 stores the floating-point program 31 and the floating-point sample data 32 in advance.

The sample data processing circuit 101 acquires the floating-point version program 31 and the floating-point sample data 32 from the memory 108. Next, the sample data processing circuit 101 executes the floating-point version program 31 with each floating-point sample data 32 as input data. Then, the sample data processing circuit 101 acquires input data for each operation included in the floating-point version program 31 and output data from each operation. Thereafter, the sample data processing circuit 101 outputs the input/output data of each operation to the operation transformation determination circuit 102. This sample data processing circuit 101 is an example of an “acquisition circuit.”

The operation transformation determination circuit 102 receives input/output data of each operation included in the floating-point version program 31 from the sample data processing circuit 101. Next, the operation transformation determination circuit 102 extracts one operation from the operations included in the floating-point version program 31, as a determination target operation. Then, the operation transformation determination circuit 102 acquires the maximum value and the minimum value of the input data of the determination target operation. In addition, the operation transformation determination circuit 102 obtains the frequency distribution of the input data of the determination target operation. In addition, the operation transformation determination circuit 102 acquires the maximum value and the minimum value of the output data of the determination target operation. Further, the operation transformation determination circuit 102 obtains the frequency distribution of the output data of the determination target operation.

Next, the operation transformation determination circuit 102 determines whether or not the maximum value, the minimum value, and the frequency distribution of the input data of the determination target operation and the maximum value, the minimum value, and the frequency distribution of the output data of the determination target operation fall within a specific range. When it is determined that the maximum value, the minimum value, and the frequency distribution of the input data of the determination target operation and the maximum value, the minimum value, and the frequency distribution of the output data of the determination target operation fall within the specific range, the operation transformation determination circuit 102 determines that the determination target operation is a transformable operation that can be transformed into a fixed-point format. Meanwhile, when it is determined that the maximum value, the minimum value, and the frequency distribution of the input data and the maximum value, the minimum value, and the frequency distribution of the output data do not fall within the specific range, the operation transformation determination circuit 102 determines that the determination target operation is an operation that is difficult to be transformed into a fixed-point format. Then, the operation transformation determination circuit 102 acquires a Q notation indicating a position of a decimal point of a numerical value when each transformable operation is transformed into a fixed-point format.

The Q notation is also called Q format. For example, the Q notation of N-bit fixed-point is denoted as Qm,n, where m+n=N−1. This is because one bit is used to represent positive and negative signs of a numerical value. The range of numerical values that can be expressed by the Q notation denoted as Qm,n is −2^{m} to +2^{m}−2⁻ⁿ, and its accuracy is 2⁻ⁿ.

Details of the determination processing by the operation transformation determination circuit 102 and the determination processing of the Q notation will be described below. Since the sum of m and n is constant in the Q notation, there is a trade-off relationship between an expressible numerical value range and an accuracy. Therefore, when the expressible numerical value range is widened, the accuracy for discriminating individual data decreases. Conversely, when the expressible numerical value range is narrowed to take the accuracy, the possibility of occurrence of data that exceeds that range increases. A state in which data exceeding the range has occurred is called “saturation,” and data which does not exceed the range in the saturation state corresponds to the maximum value or the minimum value that can be expressed in the Q notation.

In either case of where the expressible numerical value range is widened or where the expressible numerical value range is saturated, there is a concern that the number of repetitive executions up to the convergence of the deep learning increases or the deep learning does not converge forever. Therefore, when the deep learning is performed with a fixed-point format, the range of Q notation that converges on the same degree as a deep learning convergence in the floating-point format is preferably predetermined. The range of Q notation differs depending on individual deep learning program. Therefore, the operation transformation determination circuit 102 acquires the Q notation for the determination target operation with actual measurement by the following method.

The operation transformation determination circuit 102 measures the number of repetitive executions up to the deep learning convergence when the floating-point sample data 32 is used in the floating-point version program 31. Next, the operation transformation determination circuit 102 temporarily determines the Q notation of the fixed-point version program 33 from the maximum value, the minimum value, and the frequency distribution of the input data. Next, the operation transformation determination circuit 102 executes the fixed-point version program 33 with the temporarily determined Q notation. Then, the operation transformation determination circuit 102 uses the temporarily determined Q notation in the floating-point version program 31 to obtain the number of repetitive executions when the program transformed into the fixed-point format is executed. Then, the operation transformation determination circuit 103 updates the Q notation when the obtained number of repetitive execution greatly exceeds the number of repetitive executions when the original floating-point version program 31 is executed.

Thereafter, the operation transformation determination circuit 102 executes a program in which the determination target operation in the floating-point version program 31 is transformed into the fixed-point format using the updated Q notation, and compares the number of repetitive executions again. The operation transformation determination circuit 102 repeats the updating of the Q notion until the number of repetitive executions when the program in which the determination target operation is transformed into the fixed-point format is executed does not greatly exceed the number of repetitive executions when the floating-point version program 31 is executed. In a case where the number of repetitive executions when the program in which the determination target operation is transformed into the fixed-point format is executed is equal to the number of repetitive executions when the floating-point version program 31 is executed, the operation transformation determination circuit 102 determines that the determination target operation is a transformable operation. Then, the operation transformation determination circuit 102 sets the Q notation at that point as a Q notation of the fixed-point to be used for the determination target operation. For example, when the difference between the numbers of repetitive executions becomes equal to or smaller than a predetermined threshold value, the operation transformation determination circuit 102 determines that the numbers of repetitive executions are equal or so.

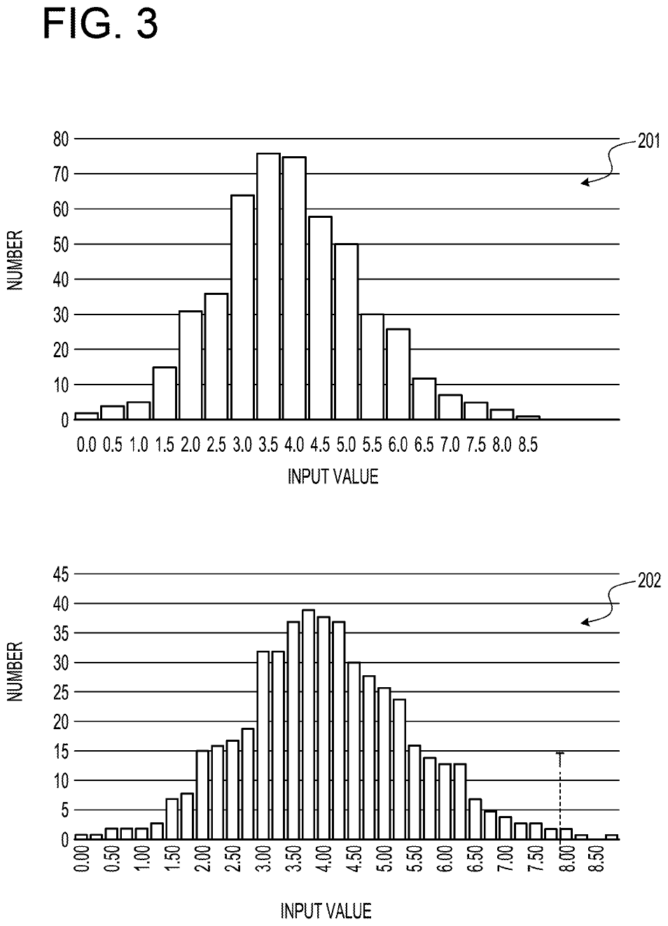

For example, the determination processing by the operation transformation determination circuit 102 and the determination processing of the Q notation will be described with the input data as an example. Here, descriptions will be made on a case where the input data is represented by a graph 201 in FIG. 3 according to the maximum value, the minimum value, and the frequency distribution of the input data. FIG. 3 is a view for explaining the determination processing of the Q notation. Graphs 201 and 202 represent the distribution of the input data, in which a vertical axis represents a number and a horizontal axis represents an input value as the value of the input data.

When an 8-bit fixed-point is used, since the maximum value is 8.5 and the minimum value is 0.0, the operation transformation determination circuit 102 temporarily determines the Q notation as Q4.3. The Q4.3 has an expression range of −16 to 15.875 and an accuracy of 0.125. The operation transformation determination circuit 102 executes the deep learning with the Q notation as Q4.3 when the determination target operation is transformed into the fixed-point format. When the deep learning converges with the same number of repetitive executions as in the floating-point format, the operation transformation determination circuit 102 determines that the determination target operation is a transformable operation and the Q notation thereof is Q4.3.

Meanwhile, when the deep learning does not converge with the same number of repetitive executions as in the floating-point format, the operation transformation determination circuit 102 changes the Q notation to, for example, Q3.4. The Q3.4 has an expression range of −8 to 7.9325 and an accuracy of 0.0625. In this case, in the graph 202, the input data exceeding the maximum value T which is 7.9325 is saturated. However, in the case of Q3.4, the accuracy of data expression is higher than that in the Q notation of Q4.3. The operation transformation determination circuit 102 executes the deep layer learning with the Q notation as Q3.4 when the determination target operation is set to the fixed-point format. When the deep learning converges with the same number of repetitive executions as in the floating-point format, the operation transformation determination circuit 102 determines that the determination target operation is a transformable operation and the Q notation thereof is Q3.4.

By performing the above-described processing, the operation transformation determination circuit 102 determines whether or not the determination target operation is a transformable operation, and when the determination target operation is a transformable operation, determines the Q notation of the determination target operation. The operation transformation determination circuit 102 repeatedly executes this determination processing for all operations included in the floating-point version program 31. Then, the operation transformation determination circuit 102 outputs information of the operation determined to be a transformable operation to the alternative function acquisition circuit 103. Further, the operation transformation determination circuit 102 outputs information of the Q notation determined for each operation determined to be a transformable operation to the transformation circuit 105. This operation transformation determination circuit 102 is an example of a “specific circuit.”

The alternative function acquisition circuit 103 receives the information of the operation determined to be a transformable operation from the operation transformation determination circuit 102. Next, the alternative function acquisition circuit 103 determines whether or not a function representing each operation determined to be a transformable operation is a complicated function where a design of an arithmetic circuit for transformation into a fixed-point format is difficult. The complicated function may also be defined as a function whose digit number of output for input is equal to or larger than a predetermined value. The complicated function includes, for example, a transcendental function, a function for obtaining a square root, and the like. However, the complicated function may be other function as long as a design of an arithmetic circuit for transformation into a fixed-point format is difficult, such as a function for exponentiation calculation, or the like. The exponentiation calculation may include, for example, x², x³, x⁻¹ (1/x), x^{1/2} (√x), x^{1/2} (1/√x) and the like. An operation represented by this complicated function corresponds to an example of a “specific operation.”

The alternative function acquisition circuit 103 selects one operation from operations represented by the complicated function. Next, the alternative function acquisition circuit 103 obtains the minimum value, the maximum value, and the median of the input data of the selected operation. Next, the alternative function acquisition circuit 103 calculates an output value which is the value of the output data of an operation corresponding to three points of the minimum value, the maximum value, and the median of the input data. Then, the alternative function acquisition circuit 103 uses the least squares method to obtain a linear approximation expression for three points indicating the minimum value, the maximum value, and the median of the input data and the output value on a coordinate representing the correspondence between the input value and the output value. Next, the alternative function acquisition circuit 103 obtains an error between the output value of the obtained linear approximation expression and the output value of the original complicated function. When the error falls within a predetermined allowable range, the alternative function acquisition circuit 103 outputs information of the linear approximation expression obtained together with the information of the operation, as an alternative function, to the substitution circuit 104 to instruct substitution of the operation. Meanwhile, when the error does not fall within the predetermined allowable range, the alternative function acquisition circuit 103 notifies to the substitution circuit 104 that substitution of the operation is not performed. The alternative function acquisition circuit 103 repeats the above-described process of determining the alternative function for all the transformable functions.

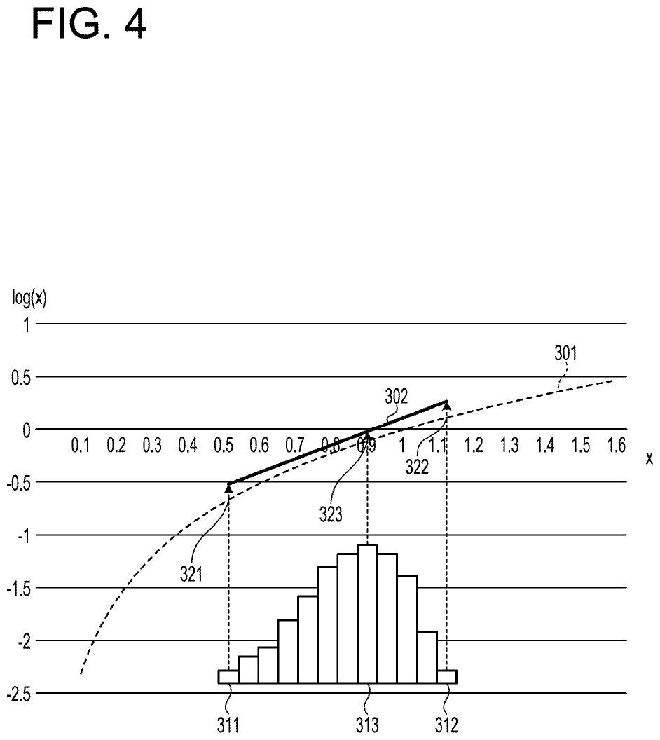

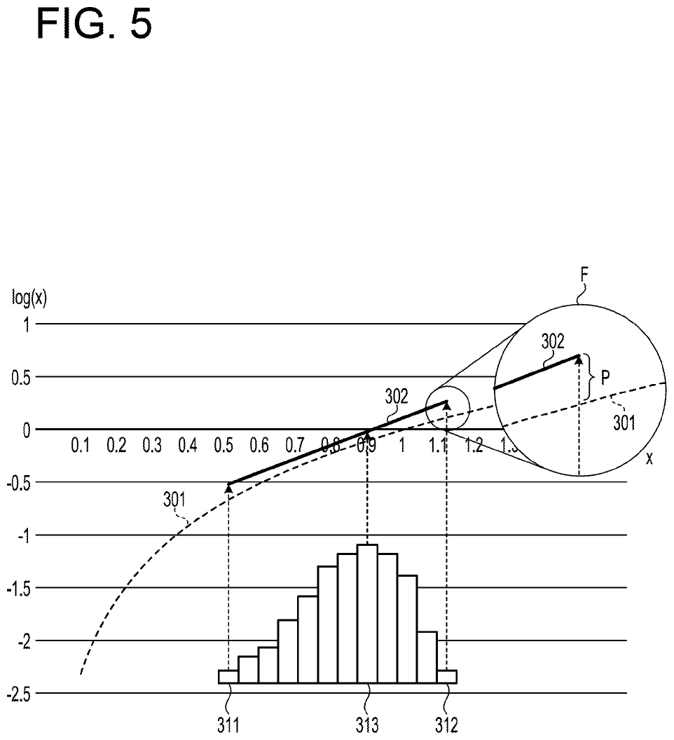

Here, the substitution of a complicated function with a linear approximation expression will be further described with reference to FIGS. 4 and 5. FIG. 4 is a view illustrating a transcendental function and a linear approximation expression. FIG. 5 is a view for explaining an error between the transcendental function and the linear approximation expression. Here, a case where the complicated function is a transcendental function of y=log(x) will be described. In FIGS. 4 and 5, a horizontal axis represents the value of x, and a vertical axis represents the value of y.

As illustrated in FIG. 4, the alternative function acquisition circuit 103 obtains a minimum value 311, a maximum value 312, and a median 313 in the input data of the transcendental function 301 of log(x). Next, the alternative function acquisition circuit 103 obtains points 321 to 323 representing output values when the minimum value 311, the maximum value 312, and the median value 313 are input values. Then, the alternative function acquisition circuit 103 uses the least squares method to obtain a linear approximation expression for the points 321 to 323. An approximation straight line 302 is a straight line represented by the linear approximation expression obtained by the alternative function acquisition circuit 103. Here, the approximation straight line 302 has a small error between the transcendental function 301 and the linear approximation expression in the vicinity of the median 313 where there are many input data. Next, the alternative function acquisition circuit 103 obtains the maximum error between the approximation straight line 302 and the transcendental function 301 within the range of the input data. Here, the maximum error is obtained at the maximum value 312 of the input value. A frame F in FIG. 5 represents an enlargement of the approximation straight line 302 and the transcendental function 301 in the vicinity of the maximum value 312 of the input value. The alternative function acquisition circuit 103 acquires an error P which is the maximum error between the approximation straight line 302 and the transcendental function 301 within the range of the input data. Then, the alternative function acquisition circuit 103 determines that the transcendental function 301 can be substituted with the approximation straight line 302 when the error P which is the maximum error within the range of the input data is within an allowable range. The alternative function acquisition circuit 103 corresponds to an example of a “function acquisition circuit.”

The substitution circuit 104 receives from the alternative function acquisition circuit 103 the information of the operation for function substitution and the information of the linear approximation expression corresponding to the operation. Next, the substitution circuit 104 acquires the floating-point version program 31 from the memory 108. Then, the substitution circuit 104 substitutes a function representing an operation instructed for function substitution among operations in a program included in the floating-point version program 31 from a complicated function to a linear approximation expression. Thereafter, the substitution circuit 104 outputs the floating-point version program 31, which has been subjected to the substitution from the complicated function of the specified operation to the linear approximation, to the transformation circuit 105.

The transformation circuit 105 receives from the substitution circuit 104 the floating-point version program 31 which has been subjected to the substitution from the complicated function to the linear approximation expression. In addition, the transformation circuit 105 receives from the operation transformation determination circuit 102 the Q notation of each transformable operation included in the floating-point version program 31. Next, the transformation circuit 105 scans the operations included in the floating-point version program 31 in order from the top, and specifies a transformable operation. Then, the transformation circuit 105 transforms each specified transformable operation into a fixed-point format designated by the transformation circuit 105 to generate the fixed-point version program 33. Further, the transformation circuit 105 determines whether or not the input data of each operation transformed into the fixed-point format is a floating-point. For the operation in which the input data is a floating-point, the transformation circuit 105 inserts, into the fixed-point version program 33, a process of transforming the input data into the fixed-point with the Q notation given to the operation. Thereafter, the transformation circuit 105 outputs the fixed-point version program 33 to the input/output adjustment circuit 106.

The input/output adjustment circuit 106 receives the fixed-point version program 33 from the transformation circuit 105. Next, the input/output adjustment circuit 106 scans the operations included in the fixed-point version program 33 in order from the top, and extracts an operation that remains in the floating-point format without being transformed into the fixed-point format. Next, the input/output adjustment circuit 106 determines whether or not the input data for each extracted operation of the floating-point format is of a fixed-point format. Then, the input/output adjustment circuit 106 inserts, into the fixed-point version program 33, a process of transforming the input data of an operation having the input data of the fixed-point format, among the extracted operations, into the floating-point format.

Next, when the output data of the extracted operation of the floating-point format is the input data of an operation of another fixed-point format, the input/output adjustment circuit 106 inserts, into the fixed-point version program 33, a process of transforming the output data into the fixed-point format with the Q notation given to a later operation. Thereafter, the input/output adjustment circuit 106 outputs to the final output adjustment circuit 107 the fixed-point version program 33 whose input/output adjustment has been completed.

The final output adjustment circuit 107 receives from the input/output adjustment circuit 106 the fixed-point version program 33 whose input/output adjustment has been completed. Then, the final output adjustment circuit 107 determines whether or not the final output data of the fixed-point version program 33 is of a floating-point format. When it is determined that the final output data is of a floating-point format, the final output adjustment circuit 107 inserts, into the fixed-point version program 33, a process of transforming the final output data into the fixed-point format, and generates the final fixed-point version program 33. Meanwhile, when it is determined that the final output data is not of a floating-point format, the final output adjustment circuit 107 sets the acquired fixed-point version program 33 as the final fixed decimal point program 33. Thereafter, the final output adjustment circuit 107 stores the final fixed-point version program 33 in the memory 108.

The deep learning execution circuit 109 receives input data from an operator. Then, the deep learning execution circuit 109 reads out the fixed-point version program 33 stored in the memory 108 and executes the deep learning using the received data.

The deep learning execution circuit 109 according to the present embodiment performs a process of updating a decimal point position of each variable in each operation included in the fixed-point version program 33 so as to suppress the amount of overflow during the execution of the deep learning. For example, the deep learning execution circuit 109 starts the deep learning using the Q notation allocated to each operation included in the fixed-point version program 33 stored in the memory 108. Then, the deep learning execution circuit 109 saves the number of overflows of each variable of each layer as statistical information. When an overflow occurs in the variable, the deep learning execution circuit 109 performs saturation processing on the variable and continues the deep learning. Here, the saturation processing is a process of ignoring overflowed upper digits.

Then, the deep learning execution circuit 109 obtains an overflow rate from the number of overflows accumulated as the statistical information after completion of the deep learning, and adjusts a decimal point position of a fixed-point to be used in each operation of the fixed-point version program 33 based on the obtained overflow rate. Thereafter, the deep learning execution circuit 109 uses the fixed-point version program 33 with the adjusted decimal point position of the fixed-point, to again perform the deep learning while counting the number of overflows. The deep learning execution circuit 109 terminates the deep learning when the state of the deep learning satisfies a predetermined condition. For example, the deep learning execution circuit 109 terminates the deep learning when an error in all the fully connected layers is equal to or less than a reference value or the number of times of learning reaches a predetermined maximum value.

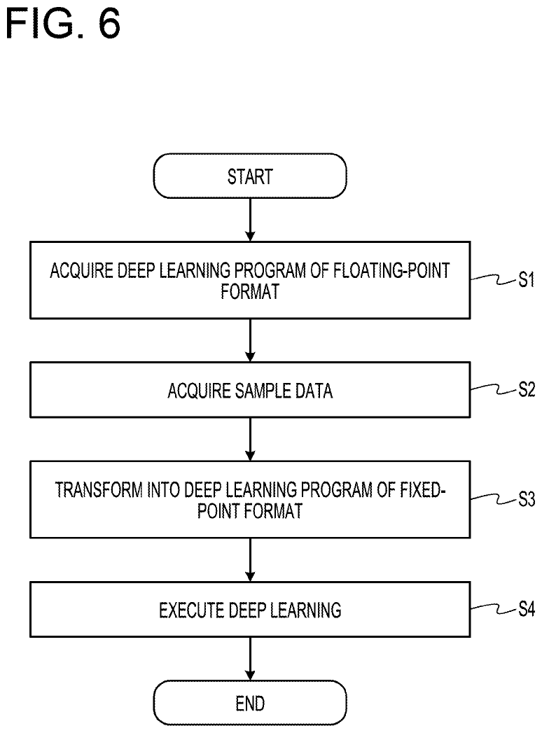

Next, the overall flow of processing of the deep learning by the arithmetic processing apparatus 1 according to the present embodiment will be described with reference to FIG. 6. FIG. 6 is a flowchart of processing of the deep learning by the arithmetic processing apparatus according to the first embodiment.

The sample data processing circuit 101 acquires from the memory 108 the floating-point version program 31 which is a program for the deep learning of a floating-point format (step S1).

In addition, the sample data processing circuit 101 acquires the floating-point sample data 32 from the memory 108 (step S2).

Next, the sample data processing circuit 101, the operation transformation determination circuit 102, the alternative function acquisition circuit 103, the substitution circuit 104, the transformation circuit 105, the input/output adjustment circuit 106, and the final output adjustment circuit 107 generate the fixed-point version program 33 which is a deep learning program of a fixed-point format (step S3). Thereafter, the final output adjustment circuit 107 stores the generated fixed-point version program 33 in the memory 108.

Thereafter, the deep learning execution circuit 109 uses the fixed-point version program 3 stored in the memory 108 to execute the deep learning (step S4).

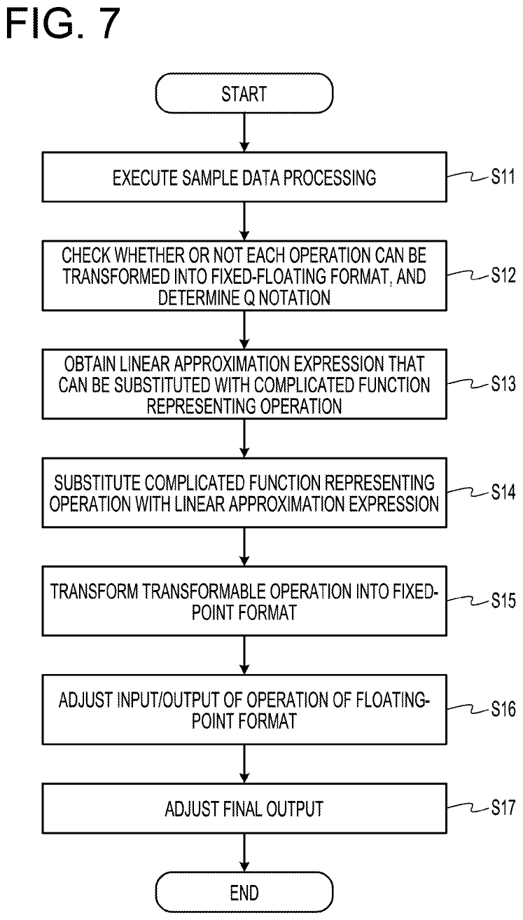

Next, the flow of transformation processing of the floating-point version program 31 into the fixed-point version program 33 will be described with reference to FIG. 7. FIG. 7 is a flowchart of transformation processing of a floating-point version program into a fixed-point version program. The flowchart illustrated in FIG. 7 corresponds to an example of the process of step S3 in FIG. 6.

The sample data processing circuit 101 uses the floating-point sample data 32 to execute the floating-point version program 31 to process the sample data (step S11). As a result, the sample data processing circuit 101 acquires input data and output data of each operation included in the floating-point version program 31. Then, the sample data processing circuit 101 outputs the input data and the output data of each operation included in the floating-point version program 31 to the operation transformation determination circuit 102.

The operation transformation determination circuit 102 receives from the sample data processing circuit 101 the input data and the output data of each operation included in the floating-point version program 31. Then, the operation transformation determination circuit 102 acquires the maximum value, the minimum value, and the frequency distribution of the input data of each operation and the maximum value, the minimum value, and the frequency distribution of the output data. Next, the operation transformation determination circuit 102 determines whether or not the maximum value, the minimum value, and the frequency distribution of the input data of each operation and the maximum value, the minimum value, and the frequency distribution of the output data fall within a specific range, and checks whether or not each operation can be transformed into a fixed-point format. Here, when it is determined that the maximum value, the minimum value, and the frequency distribution of the input data and the maximum value, the minimum value, and the frequency distribution of the output data fall within the specific range, the operation transformation determination circuit 102 determines that the operation is a transformable operation that can be transformed into the fixed-point format. Then, for each transformable operation, the operation transformation determination circuit 102 determines a Q notation when the transformable operation is transformed into the fixed-point format (step S12). Thereafter, the operation transformation determination circuit 102 outputs information of the transformable operation to the alternative function acquisition circuit 103 and the transformation circuit 105. Further, the operation transformation determination circuit 102 outputs information of the Q notation of each transformable operation to the transformation circuit 105.

The alternative function acquisition circuit 103 receives the information of the transformable operation from the operation transformation determination circuit 103. Next, the alternative function acquisition circuit 103 extracts an operation represented by a complicated function, among transformable operations. Next, the alternative function acquisition circuit 103 obtains the maximum value, the minimum value, and the median of the input data of each extracted transformable operation. Then, the alternative function acquisition circuit 103 uses the obtained maximum value, minimum value, and median of the input data to obtain a linear approximation expression of a complicated function representing each transformable operation. Next, the alternative function acquisition circuit 103 determines whether or not an error between the complicated function representing each transformable operation and its linear approximation expression falls within an allowable range. When it is determined that the error falls within the allowable range, the alternative function acquisition circuit 103 determines that the linear approximation expression obtained in the complicated function representing the transformable operation can be substituted. Meanwhile, when it is determined that the error does not fall within the allowable range, the alternative function acquisition circuit 103 determines that there is no linear approximation expression that substitutes the complicated function representing the transformable operation. In this way, the alternative function acquisition circuit 103 obtains a linear approximation expression that can be substituted by a complicated function representing an operation (step S13). Thereafter, the alternative function acquisition circuit 103 outputs to the substitution circuit 104 the information of the transformable operation represented by the substitutable complicated function and the information of the linear approximation expression to be substituted.

The substitution circuit 104 acquires from the alternative function acquisition circuit 103 the information of the transformable operation represented by the substitutable complicated function and the information of the linear approximation expression to be substituted. In addition, the substitution circuit 104 acquires the floating-point version program 31 from the memory 108. Then, the substitution circuit 104 scans the operations included in the floating-point version program 31 in order from the top and extracts a transformable operation represented by the substitutable complicated function. Next, the substitution circuit 104 substitutes the complicated function representing the extracted transformable operation in the floating-point version program 31 with the acquired linear approximation expression (step S14). Thereafter, the substitution circuit 104 outputs to the transformation circuit 105 the floating-point version program 31 in which the complicated function is substituted with a linear approximation expression.

The transformation circuit 105 receives from the substitution circuit 104 the floating-point version program 31 in which the complicated function is substituted with a linear approximation expression. In addition, the transformation circuit 105 receives from the operation transformation determination circuit 102 the information of the transformable operation. Next, the transformation circuit 105 scans the operations included in the acquired floating-point version program 31 from the top and extracts a transformable operation. Then, the transformation circuit 105 transforms the extracted transformable operation in the floating-point version program 31 into a fixed-point format to generate the fixed-point version program 33 (step S15). Further, when the input data of the operation transformed into the fixed-point format is of a floating-point format, the transformation circuit 105 inserts, into the fixed-point version program 33, a process of transforming the input data into a fixed-point format. Thereafter, the transformation circuit 105 outputs the fixed-point version program 33 to the input/output adjustment circuit 106.

The input/output adjustment circuit 106 receives the fixed-point version program 33 from the transformation circuit 105. Next, the input/output adjustment circuit 106 scans the operations included in the fixed-point version program 33 in order from the top and extracts an operation of a floating-point format. Then, the input/output adjustment circuit 106 adjusts the input/output of the extracted operation of the floating-point format (step S16). Specifically, the input/output adjustment circuit 106 determines whether or not the input data of each extracted operation of the floating-point format is of a fixed-point format. When it is determined that the input data is of a fixed-point format, the input/output adjustment circuit 106 inserts, into the fixed decimal point program 33, a process of transforming the input data of the operation of the floating-point format into a floating-point format. Further, the input/output adjustment circuit 106 determines whether or not the output data of each extracted operation of the floating-point format is the input data of an operation of a fixed-point format. When it is determined that the output data is the input data of an operation of a fixed-point format, the input/output adjustment circuit 106 inserts, into the fixed-point version program 33, a process of transforming the output data of the operation of the floating-point format into a fixed-point format. Thereafter, the input/output adjustment circuit 106 outputs to the final output adjustment circuit 107 the fixed-point version program 33 with the adjusted input/output of the operation of the floating-point format.

The final output adjustment circuit 107 receives the fixed-point version program 33 from the input/output adjustment circuit 106. Then, the final output adjustment circuit 107 adjusts the final output of the fixed-point version program 33 (step S17). Specifically, the final output adjustment circuit 107 determines whether or not the final output data is of a floating-point format. When it is determined that the final output data is of a floating-point format, the final output adjustment circuit 107 inserts, into the fixed-point version program 33, a process of transforming the final output data into a fixed-point format. Thereafter, the final output adjustment circuit 107 stores the fixed-point version program 33 in the memory 108.

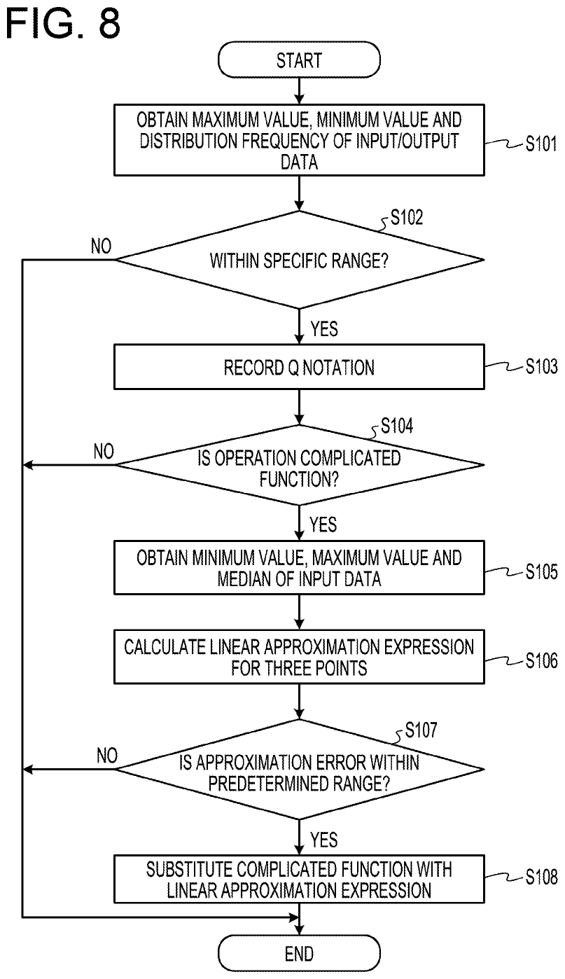

Next, a flow of processing of extraction of a transformable operation and substitution of a complicated function will be described with reference to FIG. 8. FIG. 8 is a flowchart of extraction of a transformable operation and substitution of a complicated function. The flow illustrated in FIG. 8 corresponds to an example of processing executed in steps S12 to S14 in FIG. 7. In FIG. 8, a description will be given of a case where processing for a specific operation is performed.

The operation transformation determination circuit 102 obtains the maximum value, the minimum value, and the distribution frequency of input data and output data in a specific operation (step S101).

The operation transformation determination circuit 102 determines whether or not the maximum value, the minimum value, and the distribution frequency of the input data and the output data fall within a specific range while changing a Q notation. When it is determined that the maximum value, the minimum value, and the distribution frequency of the input data and the output data do not fall within the specific range (“No” in step S102), the operation transformation determination circuit 102 ends the function substitution processing for the specific operation.

Meanwhile, when it is determined that the maximum value, the minimum value, and the distribution frequency of the input data and the output data fall within the specific range (“Yes” in step S102), the operation transformation determination circuit 102 determines that the specific operation is a transformable operation. Then, the operation transformation determination circuit 102 records a Q notation when the maximum value, the minimum value, and the distribution frequency of the input data and the output data fall within the specific range, as a Q notation when transforming the specific operation into a fixed-point format (step S103). Thereafter, the operation transformation determination circuit 102 outputs the information of the specific operation, which is a transformable operation, to the alternative function acquisition circuit 103.

The alternative function acquisition circuit 103 receives from the operation transformation determination circuit 102 the information of the specific operation which is a transformable operation. Then, the alternative function acquisition circuit 103 determines whether or not the specific operation is a complicated function (step S104). When it is determined that the specific operation is not a complicated function (“No” in step S104), the alternative function acquisition circuit 103 ends the function substitution processing for the specific operation.

Meanwhile, when it is determined that the specific operation is a complicated function (“Yes” in step S104), the alternative function acquisition circuit 103 obtains the maximum value, the minimum value, and the median of the input data of the specific calculation (step S105).

Next, the alternative function acquisition circuit 103 obtains output data corresponding to the maximum value, the minimum value, and the median of the input data. Then, the alternative function acquisition circuit 103 uses the least squares method to calculate a linear approximation expression for three points on a complicated function representing a specific operation corresponding to the maximum value, the minimum value, and the median of the input data in a coordinate representing the input data and the output data (step S106).

Next, the alternative function acquisition circuit 103 obtains a difference between the complicated function representing the specific operation and its linear approximation expression, and determines whether or not an approximation error by the linear approximation expression falls within a predetermined range (step S107). When it is determined that the approximation error does not fall within the predetermined range (“No” in step S107), the alternative function acquisition circuit 103 ends the function substitution processing for the specific operation.

Meanwhile, when it is determined that the approximation error falls within the predetermined range (“Yes” in step S107), the alternative function acquisition circuit 103 substitutes the complicated function representing the specific operation with the linear approximation expression (step S108). Thereafter, the alternative function acquisition circuit 103 ends the function substitution processing for the specific operation.

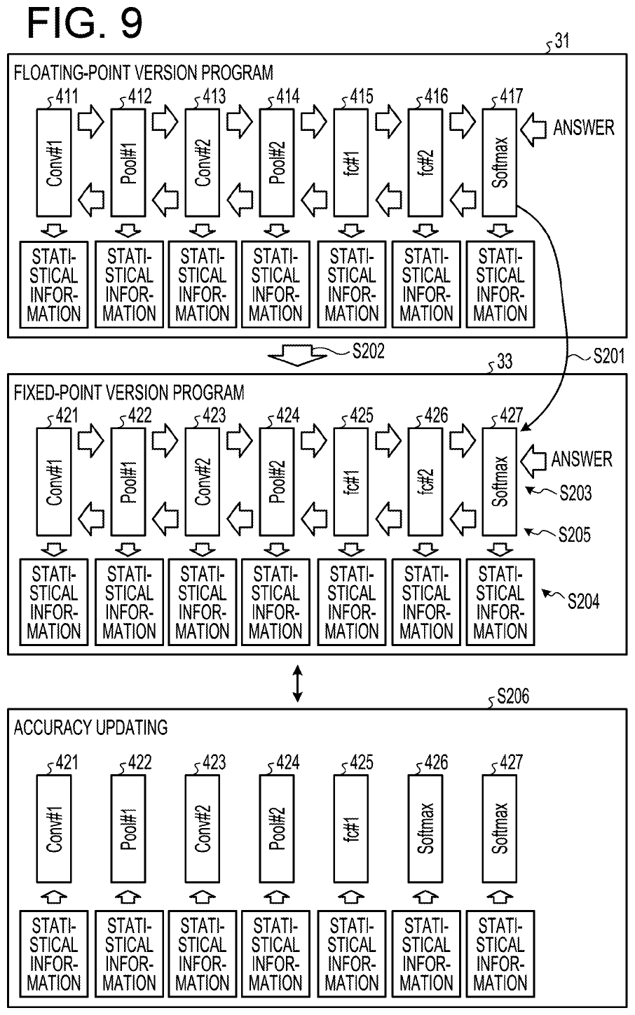

Next, a flow of entire deep learning by the arithmetic processing apparatus 1 according to the present embodiment will be described in detail with reference to FIG. 9. FIG. 9 is a view for explaining a flow of the entire deep learning by the arithmetic processing apparatus according to the first embodiment.

The memory 108 holds the floating-point version program 31. The floating-point version program 31 includes, for example, a convolution layer 411, a pooling layer 412, a convolution layer 413, a pooling layer 414, a fully connected layer 415, a fully connected layer 416, and a Softmax layer 417. When executing the floating-point version program 31, the arithmetic processing apparatus 1 performs an operation in each layer. The operations in the convolution layer 411, the pooling layer 412, the convolution layer 413, the pooling layer 414, the fully connected layer 415, the fully connected layer 416, and the Softmax layer 417 are operations of a floating-point format. Here, a case where an exponential function which is a complicated function is used in the Softmax layer 417 and a complicated function is not used in other layers will be described.

The substitution circuit 104 substitutes the exponential function in the Softmax layer 417 with a linear approximation expression (step S201). Further, the transformation circuit 105 transforms a transformable operation in the convolution layer 411, the pooling layer 412, the convolution layer 413, the pooling layer 414, the fully connected layer 415, the fully connected layer 416, and the Softmax layer 417 into a fixed-point format. Here, the transformation circuit 105 generates a convolution layer 421, a pooling layer 422, a convolution layer 423, a pooling layer 424, a fully connected layer 425, a fully connected layer 426, and a Softmax layer 427. In addition, when the input data to the operation transformed into the fixed-point format is of a floating-point format, the transformation circuit 105 inserts a process of transforming the input data into a fixed-point format. Further, the transformation circuit 105 adjusts the input/output of the operation of the floating-point format and adjusts the final output. As a result, the fixed-point version program 33 is generated (step S202).

Thereafter, the deep learning execution circuit 109 starts the deep learning using the fixed-point version program 33 (step S203). The deep learning execution circuit 109 stores the number of overflows in each operation of each layer as statistical information (step S204). Then, when an overflow occurs during the deep learning, the deep learning execution circuit 109 executes saturation processing (step S205).

After completion of the deep learning of a predetermined number of times, the deep learning execution circuit 109 obtains an overflow rate from the number of overflows held as the statistical information. Next, when the overflow rate exceeds a prescribed value, the deep learning execution circuit 109 lowers the decimal point position of a fixed-point in the operation by one and expands the integer part by one bit. In addition, when the value of twice the overflow rate is equal to or smaller than the prescribed value, the deep learning execution circuit 109 raises the decimal point position of the fixed-point in the operation by one and reduces the integer part by one bit. In this way, the deep learning execution circuit 109 updates the decimal point position of each operation of each layer, so as to update the accuracy of the fixed-point version program 33 (step S206). Then, the deep learning execution circuit 109 returns to step S203 to perform the deep learning using the fixed-point version program 33 having the updated accuracy. The deep learning execution circuit 109 ends the deep learning when an error in the fully connected layer 427 becomes equal to or less than a reference value or the number of times of the deep learning reaches a predetermined maximum value.

Here, as described above, the arithmetic processing apparatus 1 according to the present embodiment performs the process of updating the decimal point position to increase the accuracy of the deep learning, but in a case where a somewhat low accuracy of the deep learning is acceptable, the process of updating the decimal point position does not have to be performed.

As described above, the arithmetic processing apparatus according to the present embodiment substitutes a complicated function where a design of an arithmetic circuit is difficult, such as a transcendental function, with an approximation straight line, and transforms a program of a floating-point format into a program of a fixed-point format. As a result, it is possible to increase the number of operations that can be transformed into an operation of a fixed-point format among the operations included in the program of the floating-point format. Therefore, it is possible to alleviate an increase in hardware cost, execution time, and power consumption due to the complicated function. In addition, it is possible to avoid insertion of a format transforming process between a floating-point format and a fixed-point format when a complicated function is left intact, thereby suppressing an increase in cost and processing time due to the insertion of the format transforming process. That is, it is possible to implement a reduction in size, power saving, and speeding-up of a circuit that executes a program.

### Second Embodiment

Next, a second embodiment will be described. An arithmetic processing apparatus 1 according to the second embodiment is different from that in the first embodiment in that the former uses a function other than the linear approximation expression as an alternative function. The arithmetic processing apparatus 1 according to the second embodiment is also represented by the block diagram of FIG. 2. In the following description, explanation of the same functions of the respective circuits as those of the first embodiment will be omitted.

The alternative function acquisition circuit 103 sequentially selects, one by one, operations that perform function substitution, among transformable operations that are represented by a complicated function. Then, the alternative function acquisition circuit 103 acquires the maximum value, the minimum value, and the median of the input data of the selected operation. Next, the alternative function acquisition circuit 103 calculates the output data of the selected operation when the maximum value, the minimum value, and the median of the input data are used.

Then, the alternative function acquisition circuit 103 specifies three points on the selected operation in the case of the maximum value, the minimum value, and the median of the input data on a coordinate representing the input data and the output data. Next, the alternative function acquisition circuit 103 acquires an alternative function approximately representing a complicated function representing an operation selected using polygonal approximation. Then, the alternative function acquisition circuit 103 outputs to the substitution circuit 104 the alternative function obtained using the polygonal approximation as a function to be substituted for the complicated function representing the operation, together with the information of the operation for which substitution has been determined.

The substitution circuit 104 receives from the alternative function acquisition circuit 103 the alternative function obtained using the polygonal approximation, together with the information of the operation for which substitution has been determined. Then, the substitution circuit 104 substitutes a complicated function representing a designated operation among the operations in the floating-point version program 31 acquired from the memory 108 with the alternative function obtained using the polygonal approximation.

In this way, when an operation included in the floating-point version program 31 is represented by a complicated function, the complicated function can be substituted with an alternative function obtained using the polygonal approximation. In addition, here, the alternative function acquisition circuit 103 obtains a function approximate to the complicated function using the polygonal approximation, but other approximations may be used. For example, the alternative function acquisition circuit 103 may use quadratic approximation, Bezier curve approximation or the like. That is, the alternative function acquisition circuit 103 may use an approximation expression having a smaller computation amount than the original complicated function to approximate the complicated function, irrespective of the kind of the approximation expression.

For example, in the case of using the Bezier curve approximation, the alternative function acquisition circuit 103 obtains a value of the original complicated function for the maximum value and the minimum value of the input data. In addition, the alternative function acquisition circuit 103 acquires the value of the original complicated function for a value to be divided by N−2 by partition at regular intervals between the maximum value and the minimum value of the input data. Then, the alternative function acquisition circuit 103 can obtain an alternative function in the case of using the Bezier curve approximation by obtaining a smooth curve passing through both ends of a point representing the acquired N values and approaching the remaining points.

As described above, the arithmetic processing apparatus according to the second embodiment can substitute a complicated function with an algebra function obtained by using an approximation expression having a smaller computation amount than complicated functions to be substituted other than the linear approximation expression. In this way, using an approximate equation having a smaller computation amount than complicated functions to be substituted other than the linear approximation expression, it is possible to obtain an alternative function that substitutes a complicated function, thereby implementing reduction in size, power saving, and speeding-up of a circuit for executing a program.

### Third Embodiment

Next, a third embodiment will be described. An arithmetic processing apparatus 1 according to the third embodiment is different from that in the first embodiment in that the former uses a predetermined approximation expression correspondence table to determine an alternative function. The arithmetic processing apparatus 1 according to the third embodiment is also represented by the block diagram of FIG. 2. In the following description, explanation of the same functions of the respective circuits as those of the first embodiment will be omitted.

The memory 108 pre-stores a correspondence table in which approximation expressions corresponding to the maximum value and minimum value of input data are registered for different types of complicated functions.

The alternative function acquisition circuit 103 acquires the types of complicated functions representing an operation to be substituted. Further, the alternative function acquisition circuit 103 acquires the maximum value and the minimum value of the input data of the operation. Next, the alternative function acquisition circuit 103 reads the correspondence table of the acquired types of complicated functions from the memory 108. Then, the alternative function acquisition circuit 103 acquires an approximation expression corresponding to the maximum value and the minimum value of the input data acquired from the read correspondence table. Subsequently, the alternative function acquisition circuit 103 outputs to the substitution circuit 104 the approximation expression acquired as a function to substitute the complicated function representing the operation as an alternative function.

Here, in the third embodiment, a table in which the approximation expressions are associated with the maximum value and the minimum value of the input data is used, but as a parameter to be associated with the approximation expression, other values may be used as long as the values can represent a complicated function to be substituted. For example, the arithmetic processing apparatus 1 may use a correspondence table in which approximation expressions are associated with a set of the maximum value, the minimum value, and the median of input data.

As described above, the arithmetic processing apparatus according to the third embodiment uses a correspondence table registered in advance to determine an alternative function to substitute a complicated function. This facilitates a process of determining an alternative function and may shorten the time required for transformation into a fixed-point format. Therefore, it is possible to more reliably implement a reduction in size, power saving, and speeding-up of a circuit that executes a program.

Here, in each of the embodiments described above, the arithmetic processing apparatus 1 executes the deep learning, but the functions of performing the deep learning may be divided into other devices. That is, the arithmetic processing apparatus 1 executes a process of changing a floating-point format program to a fixed-point format program. Then, other information processing apparatuses may execute the deep learning by using the fixed-point format program generated by the arithmetic processing apparatus 1. Further, the floating-point format program and the floating-point format sample data may be arranged in an external storage device or other arithmetic processing apparatuses.

Further, in the above embodiments, a program that performs the deep learning as information processing of a floating-point format has been described as an example. However, other information processing may be used as long as the information processing may have a low operation accuracy and allows an operation to be transformed into a fixed-point format.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An arithmetic processing apparatus comprising:
a memory; and
a processor coupled to the memory and configured to:
acquire input data and output data in each of a plurality of operations using predetermined data for an information processing including the plurality of operations of a floating-point format to,
extract a specific operation represented by a complicated function including at least a transcendental function among the plurality of operations,
obtain an alternative function having a smaller computation amount than the complicated function in the extracted specific operation based on the input data, and
substitute the specific operation in the information processing with the alternative function.

2. The arithmetic processing apparatus according to claim 1, wherein the processor is configured to:
obtain an approximation expression of the complicated function based on the maximum value, the minimum value, and a median of the input data, and
substitute the approximation expression with the alternative function when an error between the approximation expression and the complicated function falls within an allowable range.

3. The arithmetic processing apparatus according to claim 2, wherein the processor is configured to:
obtain a linear approximation expression using least squares method based on the maximum value, the minimum value, and the median, and
substitute the linear approximation expression with the alternative function when an error between the linear approximation expression and the complicated function falls within an allowable range.

4. The arithmetic processing apparatus according to claim 1, wherein the processor is configured to:
hold in advance a correspondence table between information on the input data and an approximation expression,
obtain the approximation expression corresponding to the complicated function from the correspondence table based on the input data, and
substitute the obtained approximation expression with the alternative function.

5. The arithmetic processing apparatus according to claim 1, wherein the processor is configured to:
specify a transformable operation in which the input data and the output data fall within a predetermined range, among the plurality of operations,
transform the transformable operation into an operation of a fixed-point format,
adjust input/output of an operation other than the transformable operation, among the plurality of operations,
adjust the final output of the information processing,
extract an operation that is the transformable operation and the complicated function, as the specific operation.

6. The arithmetic processing apparatus according to claim 5,
wherein the processor is configured to specify an operation in which the maximum value, the minimum value, and the distribution frequency of the input data and the output data fall within the predetermined range, as the transformable operation.

7. A control method executed by a processor included in an arithmetic processing apparatus, the method comprising:
acquiring input data and output data in each of a plurality of operations using predetermined data for an information processing including the plurality of operations of a floating-point format to;
extracting a specific operation represented by a complicated function including at least a transcendental function among the plurality of operations;
obtaining an alternative function having a smaller computation amount than the complicated function in the extracted specific operation based on the input data; and
substituting the specific operation in the information processing with the alternative function.

8. The control method according to claim 7, the method further comprising:
obtaining an approximation expression of the complicated function based on the maximum value, the minimum value, and a median of the input data; and
substituting the approximation expression with the alternative function when an error between the approximation expression and the complicated function falls within an allowable range.

9. A non-transitory computer-readable recording medium storing a program that causes a processor included in an arithmetic processing apparatus to execute a process, the process comprising:
acquiring input data and output data in each of a plurality of operations using predetermined data for an information processing including the plurality of operations of a floating-point format to;
extracting a specific operation represented by a complicated function including at least a transcendental function among the plurality of operations;
obtaining an alternative function having a smaller computation amount than the complicated function in the extracted specific operation based on the input data; and
substituting the specific operation in the information processing with the alternative function.
